(19) United States
(12) Patent Application Publication
(10) Pub. No.: US 2007/0254755 A1
(43) Pub. Date: Nov. 1, 2007

(54) Conical disk pair for a belt-driven conical-pulley transmission

(75) Inventor: Hartmut Faust, Buhl (DE)

Correspondence Address: ALFRED J MANGELS, 4729 CORNELL ROAD, CINCINNATI, OH, 452412433, US

(73) Assignee: Luk Lamellen und Kupplungsbau Beteiligungs KG, Buhl (DE)

(21) Appl. No.: 11/728,607

(22) Filed: Mar. 25, 2007

Related U.S. Application Data
(60) Provisional application No. 60/791,261, filed on Apr. 12, 2006.

(30) Foreign Application Priority Data
Mar. 24, 2006 (DE) 10 2006 013 775.2

(51) Int. Cl. F16H 59/14

(52) U.S. Cl. 474/17

(57) ABSTRACT

A conical disk pair for a belt-driven conical-pulley transmission includes an input shaft that is rigidly connected to an axially fixed disk. An axially movable disk is rotatably carried on the shaft so that it is axially movable and rotationally fixed to the shaft. A torque sensor including shaped surfaces between which rolling elements are positioned and that axially shift a sensing piston when there is a change in the effective torque acting between the sensing piston and the shaft. The sensing piston has axially directed, circumferentially-spaced arms that extend from a side facing away from the axially movable disk and that include axial teeth that mesh with axial teeth of an input wheel rotatably carried on the shaft. A support ring is in contact with inner surfaces of the arms to maintain the teeth of the arms in engagement with the teeth of the input wheel.

### BACKGROUND OF THE INVENTION

1. Field of the Invention

The present invention relates to a conical disk pair for a belt-driven conical-pulley transmission.

2. Description of the Related Art

Belt-driven conical-pulley transmissions, such as are employed, for example, in motor vehicles, generally include two pairs of conical disks that are encircled by an endless torque-transmitting means, for example a special chain. By changing the spacing between the conical disks of each conical disk pair in opposite directions, the transmission ratio of the transmission can be varied continuously.

Advantageously, a conical disk pair, preferably the one on the power input side, includes an integrated torque sensor with that the torque acting from a drive engine is detected and a pressure between the conical disks of the corresponding disk pair is changed in accordance with the torque. For a compact type of construction of the torque sensor it is advantageous if the torque sensor is situated directly in the construction space between a support ring wall that supports the axially movable disk of the conical disk pair and that is rigidly connected to the shaft of the conical disk pair, and the axially movable disk. To make that possible, a sensing piston associated with the torque sensor has axial arms that extend through openings in the support ring wall, and that outside of the support ring wall are engaged by teeth with, for example, an input wheel driven by a drive engine.

As a result of the tooth engagement, through which the full power or the full torque of the drive engine is transferred, heavy mechanical demands are placed on the arms of the sensing piston, which must be manufactured precisely from high-quality material. Those demands can lead to problems with regard to long-term durability when operated for long periods.

An object of the present invention is to overcome the above-identified problems, i.e., to provide a design of the conical disk pair in which the arms of the sensing piston can be manufactured inexpensively while still having a long service life.

### SUMMARY OF THE INVENTION

In accordance with one aspect of the present invention, a conical disk pair for a belt-driven conical-pulley transmission includes an input shaft that is rigidly connected to an axially fixed disk. An axially movable disk is carried on the input shaft so that it is both axially movable and rotationally fixed. A torque sensing device is rigidly connected to an annular sensing piston that encircles the shaft and that is axially and rotatably movable relative to the shaft. The torque sensing device includes surfaces that are shaped in such a way that when there is a change in the effective torque acting between the sensing piston and the shaft, the axial position of the sensing piston changes by rolling elements that are situated between the shaped surfaces and that roll along the shaped surfaces. The sensing piston has axially directed arms that are circumferentially spaced from each other and that extend from its side that faces away from the axially movable disk. The arms are provided with axially-extending teeth that mesh with axially-extending teeth of a rotatably driven input wheel that is rotatably mounted on the input shaft and is axially substantially immovable. A support ring is in contact with the arms on the side radially opposite the teeth carried by the arms, and it forces the teeth of the arms to mesh with the axially-extending teeth of the input wheel.

The support ring provided in accordance with the present invention enables radial forces that act on the arms to be directly supported. Forces acting in the circumferential direction are also absorbed by the support ring.

The circumferential teeth on the axially-extending arms of the sensing piston can be formed on the radially outer side of the arms, for example, if the input wheel is designed with internal axially-extending teeth.

The support ring is advantageously in contact with the free end regions of the arms.

It is also advantageous for the transmission of force if the support ring does not axially overlap the teeth of the arms.

It is especially advantageous to attach the support ring to the arms by means of a snap connection.

For reliability of assembly, the support ring is preferably symmetrical with respect to rotation by 180° around an axis that includes a diameter of the support ring.

It is also advantageous for assembly purposes if the support ring is designed with a pre-centering step on its end faces, so that can be easily initially slid onto the free ends of the arms of the sensing piston with free play.

### BRIEF DESCRIPTION OF THE DRAWINGS

The structure, operation, and advantages of the present invention will become further apparent upon consideration of the following description, taken in conjunction with the accompanying drawings in which:

FIG. 1 is a longitudinal cross-sectional view through a conical disk pair;

FIG. 2 is a view similar to FIG. 1 with the sensing piston shifted axially;

FIG. 3 is an enlarged fragmentary cross-sectional view of a support ring as it is initially slid into contact with the arms of the sensing piston; and

FIG. 4 is an enlarged fragmentary cross-sectional view similar to FIG. 3 with the support ring slid into the arms and in its operative position.

### DESCRIPTION OF THE PREFERRED EMBODIMENTS

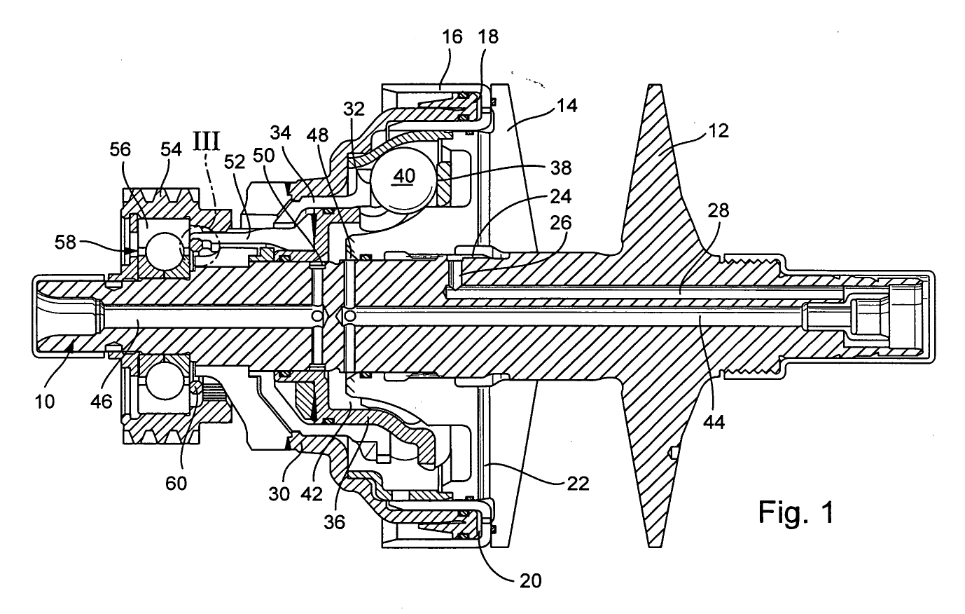

As shown in FIG. 1, a pair of conical disks of a belt-driven conical-disk transmission includes an input shaft 10 that is integrally formed with an axially fixed disk 12. Situated on shaft 10 and axially movable but non-rotatably connected to the shaft is an axially movable disk 14. An endless torque transmitting means, not shown, circulates between the conical surfaces of disks 12 and 14 as well as the conical surfaces of a further pair of conical disks (not shown).

On the back side of axially movable disk 14, the side that faces away from axially fixed disk 12, and in its radially outer region, a cylindrical annular chamber 16 defined by two annular walls that are radially spaced from each other is rigidly attached. An annular piston 18 is axially movable within chamber 16, so that on the right side of piston 18, as viewed in FIG. 1, a first pressure chamber 20 is formed. First pressure chamber 20 is subjected to hydraulic pressure through radial bores 22 in axially movable disk 14, through an annular chamber 24 between axially movable disk 14 and shaft 10, and through a radial bore 26 and an axial bore 28 in shaft 10, which hydraulic pressure is changeable to adjust the transmission ratio.

Annular piston 18 is rigidly connected to a cup-shaped support ring wall 30 that is rigidly connected to shaft 10. On the inner side of the support ring wall 30, an annular component 34 formed with shaped surfaces 32 is rigidly attached.

Also situated within the support ring wall 30, and axially movable, is an annular sensing piston 36 that is sealed against the circumferential surface of shaft 10 and an inner circumferential surface of annular component 34. Sensing piston 36 is designed with an axial extension directed toward axially movable disk 14, on an inner surface of which shaped surfaces 38 are provided that constitute countersurfaces to the shaped surfaces 32 of annular component 34. Between shaped surfaces 32 and 38 are rolling elements, in the illustrated example balls 40.

Between sensing piston 36 and axially movable disk 14 a second pressure chamber 42 is formed, which can be subjected to hydraulic pressure through a supply line 44 extending through the shaft, the hydraulic fluid being removable through a drain line 46 that is also formed in shaft 10.

The effective cross section of a supply orifice 48 that leads into the second pressure chamber 42 is determined by the axial position of axially movable disk 14. The free cross section of the drain orifice 50 leading out of the second pressure chamber is determined by the axial position of the sensing piston 36. The sensing piston 36 includes axial arms 52 that extend through openings in the support ring wall 30 and are preferably at equally spaced intervals in the circumferential direction. The radially outer surfaces of the arms 52 are provided with radial teeth that extend axially and that engage with inner teeth of an input wheel 54, which is supported and is axially substantially immovable on an external shell 56 of a bearing 58.

The construction and the function of the conical disk pair described so far are known and will therefore be explained only briefly.

When there is a torque from the rotationally drivable input wheel 54 acting on sensing piston 36, that torque is transmitted via the shaped surfaces 38, the balls 40, and the shaped surfaces 32 to the annular component 34 and thus to the shaft 10. he shaped surfaces are designed so that sensing piston 36 moves to the right, as viewed in FIG. 1, as the torque increases, so that the drain orifice 50, that is not completely covered by the sensing piston in the basic or starting position of the conical disk pair shown in FIG. 1, is increasingly closed.

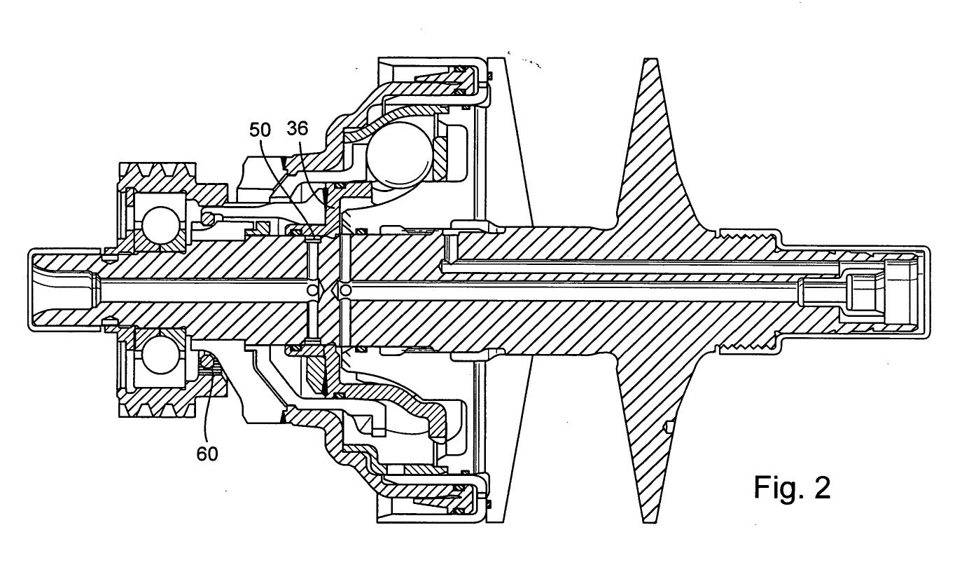

FIG. 2 shows the arrangement of FIG. 1 at a very high torque condition, at which the sensing piston 36 is shifted as far as possible to the right and completely covers the drain orifice 50. As the effective size of the drain orifice 50 becomes smaller, the pressure in the second pressure chamber 42 increases, so that a pressure that is a function of the input torque acts against axially movable disk 14.

In accordance with the invention, a support ring 60 is provided to support the free ends of the arms 52. The support ring is in contact with the radially inner sides of the end regions of the arms 52 and urges them outward, so that the outer teeth of the arms are urged into secure meshing engagement with the inner teeth of the input wheel 54.

The arms 52 are advantageously formed on an annular member that is welded to the sensing piston 36, as shown, from which they extend axially. In that way the weld the annular member that carries the arms is relieved of bending forces acting directly on the arms in a circumferential direction.

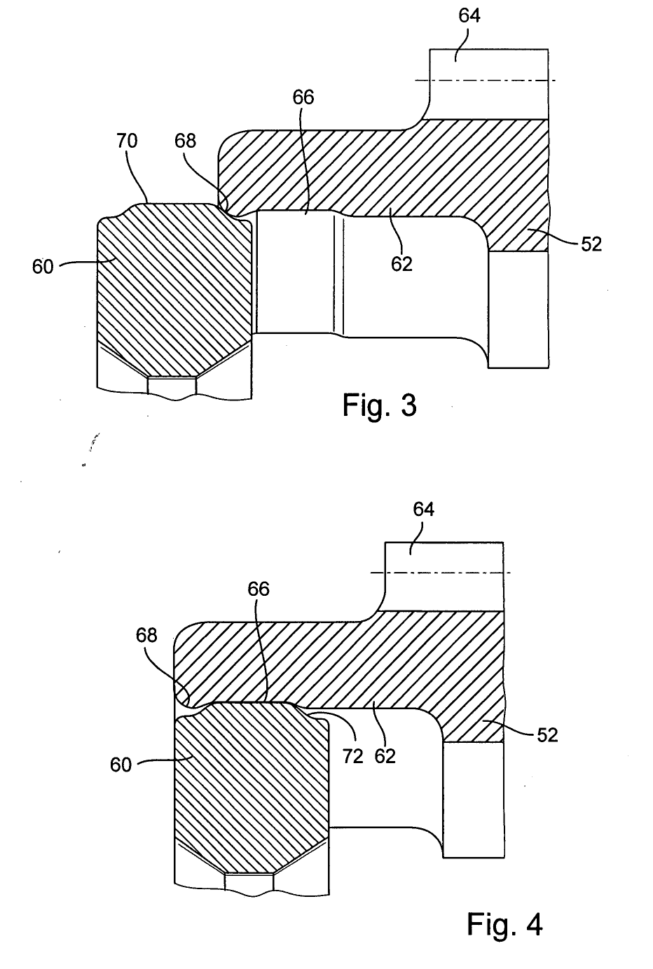

FIGS. 3 and 4 show in enlarged form the circled region in FIG. 1, including support ring 60 and the free end regions 62 of the arms 52, wherein only one arm of the advantageously at least three arms is shown.

In FIGS. 3 and 4 one of the outer teeth 64 of the arms 52 is visible, which meshes with the (unlabeled) inner teeth of input wheel 54. As can be seen from FIGS. 1 and 2, external teeth 64 can shift axially relative to the internal teeth, so that the axial movability of the sensing piston is ensured.

In accordance with FIG. 3, the inner surface at end region 62 of each arm 52 ends with a recess 66, which ends at the end face of the arm with a radially-inwardly-extending lip 68. Support ring 60 has a radially-outwardly-extending outer surface 70, which is formed to correspond in shape with recess 66 but is slightly oversized, and that transitions through an outer centering step 72 into the end face of the support ring.

Support ring 60 is advantageously designed to be symmetrical in cross section, so that it can be installed when it is turned by 180° about a diameter, i.e., support ring 60 can be slid into the arms 52, which are circumferentially spaced, from either orientation of the end faces of the support ring. The radial diameter of outer centering step 72 of support ring 60 is slightly smaller, smaller by about 0.05 mm, for example, than the smallest diameter of inwardly-extending lip 68, so that support ring 60 centers itself when it is slid into the outer ends of arms 52. When support ring 60 is slid further into arms 52, end regions 62 are urged outwardly until the outer surface 70 of support ring 60 is received in recess 66 and the end regions 62 spring back inwardly, so that inwardly-extending lips 68 extend beyond the outer surface 70 of support ring 60 and snap into position. The oversizing of the largest diameter of outer surface 70 of support ring 60 compared to the smallest inside diameter of cutout 66 can be of the order of magnitude of about 0.15 mm, for example.

As can be seen, when it is inserted into the arms 52 the support ring 60 is preferably located somewhat axially beyond the outer teeth 64, in which region the arms 52 have somewhat greater radial thickness than at their end regions 62.

For stabilization of the fingers 52, not only in the radial direction but also in the circumferential direction, the outer surface 70 of support ring 60 and the inner surface of the recess 66 can be knurled in the axial direction.

With the support ring in accordance with the present invention it is possible to press back distortions of the arms 52 that arose during prior processing steps, so that secure engagement of the teeth of the arms with those of the input wheel is ensured.

In the teeth of the arms a close tolerance can be maintained relative to the later joining surface with the support ring (recess 66). Independent of distortions of the arms that appear subsequently, the toothed arms are pressed into their correct position by the installed support ring.

In the described exemplary embodiment the support ring does not require any additional space, since it is situated within the thinned end regions of the arms, within an annular space that is formed between the bearing 58, the arms 52, and a seal holder.

The attachment of the support ring through the described snap connection has the advantage over mechanically rigid connections, such as welding, in that no welding or soldering is possible between the support ring and the arms on the almost-finished disk pair. It is also advantageous because during forced movements between the support ring and the arms extraordinarily high forces occur in the case of a positive connection.

The snap connection can be designed in an unlimited variety of ways. For example, a narrow snap lug can be formed on the support ring, with a radial support to the left and right of the lug. Alternatively, a wide snap lug can be formed on the ring, with the radial support occurring directly on the lug, as shown in FIGS. 3 and 4, and the snap engagement occurs on both sides of the inwardly-extending lip 68.

To avoid the formation of burrs, all edges are advantageously rounded off.

When installing the support ring, it is advantageous to monitor a force-travel curve when inserting the ring into the fingers, so that an acceptable snap connection is ensured.

In order to optimize the snap geometry, it can be advantageous to deviate from the symmetrical design of the support ring, with which symmetrical design installation is possible from both sides.

The arms, that are rigidly connected to the sensing piston, are advantageously case-hardened or carbonitrided. The support ring is advantageously made of steel, a tempering steel, for example ETG100 with Rm≈1000 MPa without additional heat treatment, case-hardening steel, hardened or carbonitrided.

It is advantageous to employ the support ring already when measuring the soft processed part with the toothed arms.

It is also advantageous to employ the support ring already during the heat treatment process to reduce distortion.

In the described exemplary embodiment the arms 52 are toothed, so that support ring 60 is situated within the arms. Alternatively, the arms can be toothed on the inside and interact with outside teeth on the input wheel. The support ring is then positioned radially outside of the arms, and forces them inward into engagement with the input wheel.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A pair of conical disks for a belt-driven conical-pulley transmission, said pair of conical disks comprising:
an input shaft that is rigidly connected to an axially fixed conical disk;
an axially movable conical disk that is non-rotatably carried on the shaft and is axially movable toward and away from the axially fixed disk;
a torque sensing device including a first shaped surface that is rigidly connected to the shaft, and a second shaped surface that is rigidly connected to an annular sensing piston that encircles the shaft and that is rotatable and axially movable relative to the shaft, wherein the shaped surfaces are formed so that when there is a change in the effective torque acting between the sensing piston and the shaft, the axial position of the sensing piston changes by the movement of rolling elements that roll along the shaped surfaces, wherein on its side facing away from the axially movable disk the sensing piston includes axially directed arms that are circumferentially spaced from each other and that include axially-extending teeth that engage with axially-extending teeth carried by rotationally driveable input wheel that is rotatably mounted on the shaft and is axially substantially immovable; and
a support ring carried by the arms and in contact with arm inner surfaces adjacent outer ends of the arms for maintaining the teeth of the arms in engagement with the teeth of the input wheel.

2. A conical disk pair in accordance with claim 1, wherein the teeth of the arms of the sensing piston are positioned on radially outer sides of the arms.

3. A conical disk pair in accordance with claim 1, wherein the support ring contacts the arms adjacent free outer end regions of the arms.

4. A conical disk pair in accordance with claim 1, wherein the support ring is axially spaced from the teeth of the arms.

5. A conical disk pair in accordance with claim 1, wherein the support ring is attached to the arms by a snap-in connection.

6. A conical disk pair in accordance with claim 1, wherein the support ring is symmetrical about a transverse plane that is perpendicular to a support ring longitudinal axis.

7. A conical disk pair in accordance with claim 1, wherein the support ring includes a reduced diameter centering step on its end faces, wherein the centering step allows the support ring to be initially slid into free outer ends of the arms of the sensing piston with free play.
